(19) United States
(12) Patent Application Publication
(10) Pub. No.: US 2026/0289365 A1
(43) Pub. Date: Sep. 24, 2026

(54) Quantum Linear Solver

(71) Applicant: PsiQuantum, Corp., Palo Alto, CA (US)

(72) Inventors: Matteo Giuseppe Lostaglio, Palo Alto, CA (US); David Jennings, Palo Alto, CA (US); Yigit Subasi, Los Alamos, NM (US)

(21) Appl. No.: 19/474,618

(22) PCT Filed: Apr. 12, 2024
(86) PCT No.: PCT/US2024/024280

§ 371 Date: Oct. 10, 2025

Related U.S. Application Data
(60) Provisional application No. 63/458,881, filed on Apr. 12, 2023.
(60) Provisional application No. 63/467,549, filed on May 18, 2023.

(51) Int. Cl. G06N 10/20; G06N 10/60

(52) U.S. Cl. CPC G06N 10/20; G06N 10/60

(57) ABSTRACT

Quantum computing devices, systems, quantum circuits and methods for solving a linear equation Ay=b. A quantum linear solver is iteratively performed until a success indicator indicates success. The quantum linear solver prepares a first plurality of qubits in the state b. An adiabatic evolution circuit is applied to the first plurality of qubits using a second plurality of qubits that have encoded as A for a plurality of time steps to unitarily evolve the first quantum state toward the target state y. After applying the adiabatic evolution circuit, a projective filter measurement is performed on the first plurality of qubits to produce the success indicator. When the success indicator indicates success, the first plurality of qubits is output as an approximation of the target state.

### PRIORITY INFORMATION

This application claims the benefit of priority to U.S. Provisional Patent Application No. 63/458,881, titled “Quantum Linear Solver” and filed Apr. 12, 2023, and U.S. Provisional Patent Application No. 63/467,549, titled “Quantum Linear Solver” and filed May 18, 2023, both of which are hereby incorporated by reference in their entirety as though fully and completely set forth herein.

### TECHNICAL FIELD

Embodiments herein relate generally to quantum computational methods, systems and devices, for solving linear equations and systems of equations.

### BACKGROUND

Solving linear equations and systems of linear equations are important applications of fault-tolerant quantum computing. A quantum linear solver may return the solution to a linear equation or system of equations encoded as classical measurement results of a quantum state. Current methods for implementing a quantum linear solver have a high computational cost, involving large numbers of qubits, long computation times, and/or expensive hardware resources. Accordingly, improvements in the field of quantum computational systems and methods used to solve linear systems of equations are desirable.

### SUMMARY

Some embodiments described herein include quantum computing devices, systems, quantum circuits and methods for solving linear equations. A quantum linear solver may receive as input a matrix A and a vector b, and may output a plurality of qubits prepared in a state y (the target state) that is a solution to the equation Ay=b.

In some embodiments, a quantum linear solver may be iteratively performed until a success indicator indicates success. The quantum linear solver may include preparing a first plurality of qubits in a first quantum state corresponding to the vector b. For each of a plurality of respective time steps, an adiabatic evolution circuit may be applied to the first plurality of qubits using a second plurality of qubits that have been encoded as A to unitarily evolve the first quantum state for the respective time step toward the target state y.

After applying the adiabatic evolution circuit for each of the plurality of respective time steps, a projective filter measurement circuit may be applied to the first plurality of qubits to produce a success indicator.

Based on a determination that the success indicator indicates success, it may be determined that the first plurality of qubits after the last iteration of applying the projective filter measurement circuit are prepared in an approximation of the target state. The first plurality of qubits may then be output as an approximation to the solution y to the linear equation Ay=b.

The techniques described herein may be implemented in and/or used with a number of different types of devices, including but not limited to photonic quantum computing devices and/or systems, hybrid quantum/classical computing systems, and any of various other quantum computing systems.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the Figures.

FIG. 1 is a system diagram illustrating a classical and quantum computing system, according to some embodiments;

FIG. 2A illustrates a quantum circuit for implementing a quantum linear solver, according to some embodiments;

FIG. 2B is a flowchart illustrating stages of a method for implementing a quantum linear solver, according to some embodiments;

FIG. 3 is a plot of computational cost for implementing a quantum linear solver as a function of condition number, according to some embodiments;

FIG. 4 is a flowchart illustrating a method for implementing a quantum linear solver, according to some embodiments;

FIG. 5 is an illustrating of implementing an adiabatic evolution circuit, according to some embodiments;

FIG. 6 is a plot of a filter function for constructing an approximate projection operator, according to some embodiments;

FIG. 7A is a quantum circuit diagram illustrating an adiabatic evolution circuit, according to some embodiments;

FIG. 7B is a quantum circuit diagram illustrating example subroutines of a single stage of the adiabatic evolution circuit; and

FIG. 8 is a quantum circuit diagram illustrating a projective filter measurement circuit, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

Disclosed herein are examples (also referred to as “embodiments”) of quantum systems and methods for estimating expectation values of arbitrary observables in arbitrary quantum states.

Although embodiments are described with specific detail to facilitate understanding, those skilled in the art with access to this disclosure will appreciate that the claimed invention may be practiced without these details. Reference will now be made in detail to embodiments, examples of which are illustrated in the accompanying drawings. In other instances, well-known methods, procedures, components, circuits, and networks have not been described in detail so as not to unnecessarily obscure aspects of the embodiments.

### Qubits

Quantum computing relies on the dynamics of quantum objects, e.g., photons, electrons, atoms, ions, molecules, nanostructures, and the like, which follow the rules of quantum theory. As used herein, a “qubit” (or quantum bit) is a quantum system with an associated quantum state that may be used to encode information. A quantum state may be used to encode one bit of information if the quantum state space can be modeled as a (complex) two-dimensional vector space, with one dimension in the vector space being mapped to logical value 0 and the other to logical value 1. In contrast to classical bits, a qubit may have a state that is a superposition of logical values 0 and 1. More generally, a “qudit” describes any quantum system having a quantum state space that may be modeled as a (complex) n-dimensional vector space (for any integer n), which may be used to encode n bits of information. For the sake of clarity of description, the term “qubit” is used herein, although in some embodiments the system may also employ quantum information carriers that encode information in a manner that is not necessarily associated with a binary bit, such as a qudit.

Qubits (or qudits) may be implemented in a variety of quantum systems. Examples of qubits include: polarization states of photons; presence of photons in waveguides; or energy states of molecules, atoms, ions, nuclei, or photons. Other examples include other engineered quantum systems such as flux qubits, phase qubits, or charge qubits (e.g., formed from a superconducting Josephson junction); topological qubits (e.g., Majorana fermions); or spin qubits formed from vacancy centers (e.g., nitrogen vacancies in diamond).

Some embodiments described below relate to physical implementations of unitary operations that couple modes of a quantum system, which may be understood as transforming the quantum state of the system. For instance, if the initial state of the quantum system (prior to mode coupling) is one in which one mode is occupied with probability 1 and another mode is unoccupied with probability 1 (e.g., a state |10 [symbol] in the Fock notation), mode coupling may result in a state in which both modes have a nonzero probability of being occupied, e.g., a state a₁|10 [symbol] +a₂|01 [symbol] , where |a₁|²+|a₂|²=1. In some embodiments, operations of this kind may be implemented by coupling modes together and applying phase shifts to one or more modes.

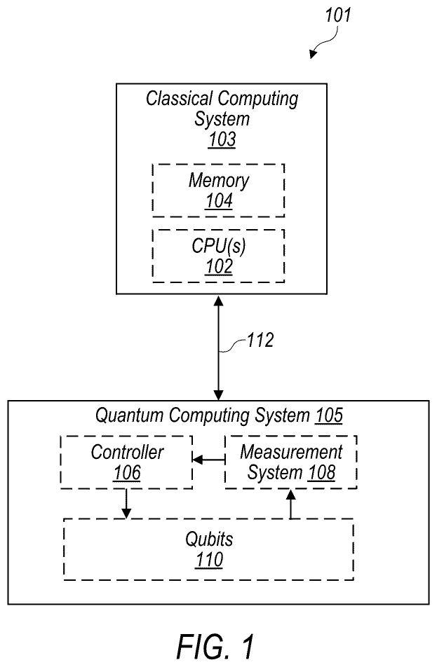

### FIG. 1—Quantum Computing System

FIG. 1 is a system diagram of a quantum computing system, according to some embodiments. As illustrated, the system includes a classical computing system 103 coupled to a quantum computing system 105 over a classical channel 112. The classical channel may relay classical information between the classical and quantum computing systems.

In some embodiments, the classical computing system 103 includes one or more non-transitory computer-readable memory media 104, one or more central processing units (CPUs) or processor(s) 102, a power supply, an input/output (I/O) subsystem, and a communication bus interconnecting these components. The processor(s) 102 may execute modules, programs, and/or instructions stored in memory 104 and thereby perform processing operations. The processor may comprise a dedicated processor, or it may be a field programmable gate arrays (FPGA), an application specific integrated circuit (ASIC), or a “system on a chip” that includes classical processors and memory, among other possibilities. In some embodiments, memory 104 stores one or more programs (e.g., sets of instructions) and/or data structures and is coupled to the processor(s).

The classical computing system may be classical (as opposed to quantum) in the sense that it operates computer code represented as a plurality of classical bits that may take a value of 1 or 0. Programs may be written in the form of ordered lists of instructions and stored within the classical (e.g., digital) memory 104 and executed by the classical (e.g., digital) processor 102 of the classical computer. The memory 104 is classical in the sense that it stores data and/or program instructions in a storage medium in the form of bits, which have a single definite binary state at any point in time. The processor may read instructions from the computer program in the memory 104 and/or write data into memory, and may optionally receive input data from a source external to the computer 103, such as from a user input device such as a mouse, keyboard, or any other input device. The processor 102 may execute program instructions that have been read from the memory 104 to perform computations on data read from the memory 104 and/or input from the quantum computing system, and generate output from those instructions. The processor 102 may store that output back into the memory 104.

The quantum computing system 105 may include a plurality of qubits and a controller 106 configured to interface with the plurality of qubits 110. The qubits may be configured to evolve in time under the directed influence of the controller, and a measurement system 108 may at times perform quantum measurements on all or a subset of the qubits to obtain quantum measurement results in the form of classical data bits (e.g., ones and zeros). The classical data from the measurement results may be intermediate results that inform behavior of the classical computing system and/or the quantum controller 106 during a quantum computation, and they may additionally include classical results of the quantum computation. The measurement results may be communicated to the classical computing system and/or the controller 106, and further the classical computing system may provide directions and/or instructions to the controller 106 and the measurement system 108 to guide the behavior of the quantum computing system to perform a quantum computation. For example, the classical computing system 103 may provide classical data signals used for quantum state preparation within the quantum computing system 105, in response to which the controller may prepare the states of the qubits 110 into a desired initial state for a particular quantum computation.

Embodiments herein describe methods, quantum circuits, and quantum computing systems for implementing a quantum linear solver to output a solution of a linear equation or system of equations encoded as classical measurement results of a quantum state.

### Quantum Linear Solvers

Quantum linear solvers (QLSs) are tasked with returning the solution of a linear system Ay=b encoded as a quantum state (alternatively represented as A|y [symbol] =|b) in bra-ket notation), where A is an operator and y and b are states. Linear systems are used in a wide variety of applications, since many problems admit reductions to linear systems. Notably, many quantum algorithms for linear and nonlinear differential equations beyond Hamiltonian simulation rely on linear solvers. Other applications include data fitting, scattering, machine learning and portfolio optimization.

A QLS encodes each of A and b within respective pluralities of qubits as quantum states, and performs a series of operations on the qubits to produce the target state y encoded within a plurality of qubits. A classical measurement may then be performed to produce classical measurement results that describe the target state y. Formally, given an error tolerance ϵ>0, a QLS outputs a quantum state ϵ-close to |y)∝A⁻¹|b [symbol] , which is the solution vector y=A⁻¹b encoded as a quantum state, which is then measured to produce classical measurement. The computational cost of the algorithm is given in terms of its query complexity Q, which is defined as the number of applications of unitary operators (‘oracles’) for state preparation of |b [symbol] and a block-encoding of A, namely a unitary encoding A/α for some α>0 in one of its blocks. This compuational cost may depend on three parameters: (ϵ, κ, α). Here e is the error tolerance, while κ is the condition number of the matrix. Finally, α is a rescaling constant, which depends on the specific block-encoding construction and it is hence problem-dependent.

In order to run QLSs on the first generations of fault-tolerant quantum computers, a reduction in the computational cost is desirable. Embodiments herein present quantum computational systems and methods to significantly reduce the computational cost (e.g., the query complexity Q), based upon a modified and optimized adiabatic evolution method. Reductions of up to 9 times the best results of previous implementations are achieved, and these savings are application- and architecture-agnostic. Hence, they can be deployed across any quantum computation using linear solvers as a subroutine.

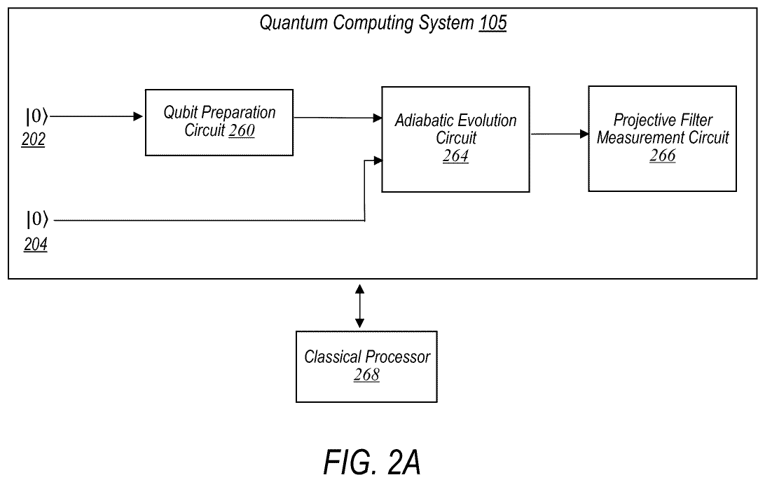

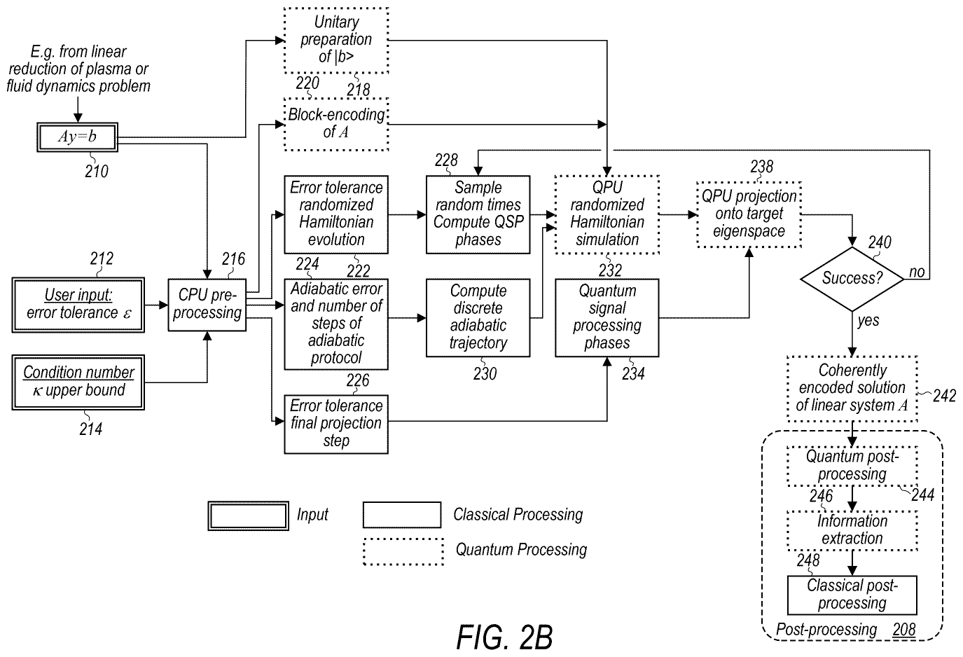

### FIGS. 2A-2B—Method for Implementing a Quantum Linear Solver

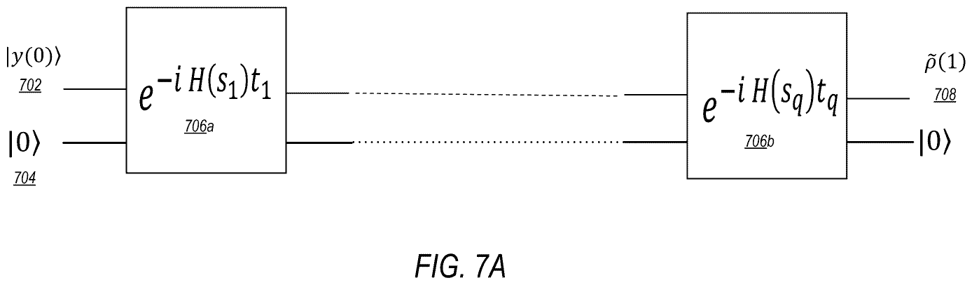

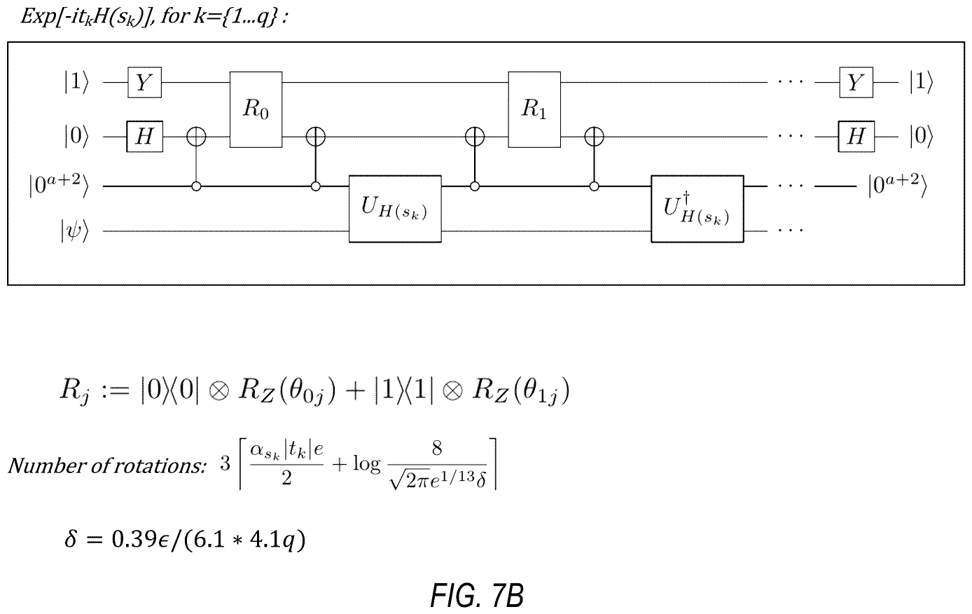

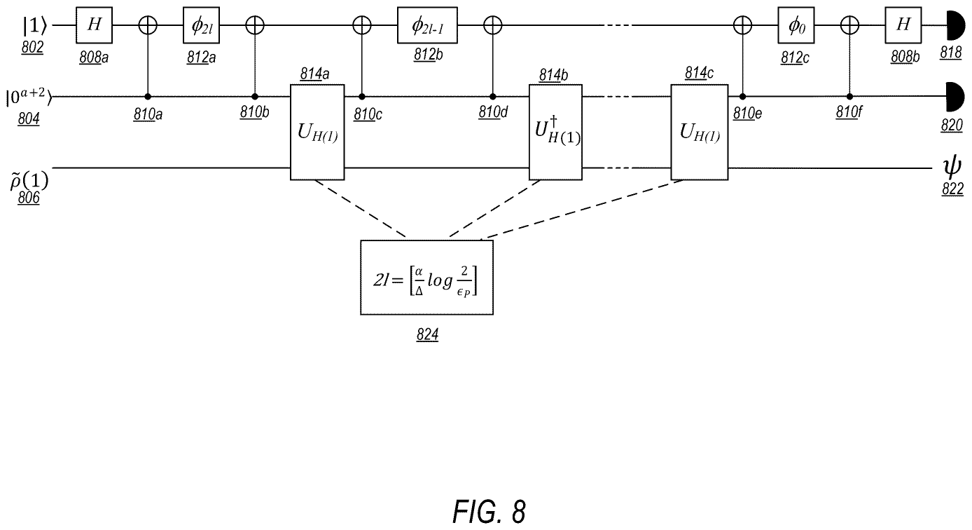

FIG. 2A illustrates a system including quantum circuits and a classical processor for implementing a quantum linear solver, according to some embodiments. A classical description of the quantum states |b [symbol] and A are received as inputs to the QLS. As illustrated in FIG. 2A, first 202 and second 204 pluralities of qubits are obtained in respective initial states. FIG. 2A shows the initial state for both plurality of qubits as the null state, |0 [symbol] , but other initial states are also possible. The first plurality of qubits is provided to a qubit preparation circuit 260, which prepares the qubits in the state |b [symbol] . The qubit preparation circuit may be comprised with the controller 106 of the quantum computing system 105 shown in FIG. 1, and may interface with the qubits 110 (which may include the first and second pluralities of qubits). The second plurality of qubits are received in a null state 204, and will be used to encode the operator A. The qubits are provided to an adiabatic evolution circuit 264 to adiabatically evolve the qubits that have been prepared in the state |b [symbol] . An example of an adiabatic evolution circuit is described in greater detail below in reference to FIG. 7A. The adiabatic evolution circuit may be a module of the controller 106 configured to interface with the qubits 110. The adiabatic evolution circuit may provide output in the form of modified qubits to a projective filter measurement circuit 266. An example of a quantum circuit configured to perform the projective filter measurement is shown in FIG. 8 and described in greater detail below. The projective filter measurement may be a module of the controller 106 configured to interface with the qubits 110, and may also include the measurement system 108.

The projective filter measurement circuit may be configured to interface with the classical processor 268 (e.g., the classical processor 102 shown in FIG. 1), to provide a success indicator. The classical processor may be configured to determine, based on the success indicator, whether the first plurality of qubits have been successfully projected into an ϵ-close approximation of the target state |y [symbol] . When the success indicator does not indicate success, the classical processor may direct the quantum computing system to discard the qubits and repeat the entire method with a new preparation of respective pluralities of qubits into initial states, etc., until success is obtained. When the success indicator indicates success, the classical processor may instruct the quantum computing system to output the qubits 202 in the desired target state for quantum and/or classical post-processing.

FIG. 2B is a high-level flowchart that illustrates various aspects of a method for implementing a quantum linear solver, according to some embodiments. The method may proceeds through a pre-processing stage, an adiabatic evolution stage, a filtering stage, and post-processing 208.

In the pre-processsing stage, parameters of a linear equation to be solved is received 210, which may be expressed in the form A|y [symbol] =|b [symbol] . For example, the operator A and a characterization of the quantum state |b [symbol] may be received, whereas |y [symbol] (called the target state) is the solution that is sought. The linear equation may be, as one example, a linear reduction of a problem in plasma or fluid dynamics, or any of a variety of other types of computational problems. The method may also receive as user input an error tolerance ϵ 212 that characterizes a numerical precision for obtaining the solution |y [symbol] . In addition, an upper bound on a condition number K of the operator A may be received 214, which may inform various aspects of the method, as described in greater detail below.

A plurality of qubits may be prepared into the state |b [symbol] through a unitary preparation stage 218, where a unitary operator is applied to a null state to obtain the state |b [symbol] , as described below in reference to Equation 2. The operator A may be block encoded using another plurality of qubits 220, and parameters for the block encoding of A may be determined based on the error tolerance ϵ and the condition number κ.

Additional classical pre-processing (e.g., performed by a classical processor such as the processor 102) may be performed 216 to determine an error tolerance for performing the randomized pseudo-Hamiltonian adiabatic evolution 222, for determining an error magnitude for the adiabatic evolution and a number of steps to use in the adiabatic evolution circuit 224, and for determining an error tolerance for the projective filter measurement 226.

In some embodiments, the solution |y [symbol] is encoded as the zero eigenstate of a Hamiltonian H(1). To obtain |y [symbol] , the zero eigenstate of a simple Hamiltonian H(0) is prepared, and the Hamiltonian is then adiabatically modified to H(1) along an appropriately chosen discrete trajectory, performing Hamiltonian simulation at each step for an appropriately randomized time (the machinery of time-dependent Hamiltonian simulation is not required). Preparing |y [symbol] to high precision in this manner may be prohibitively costly. To address this concern, in some embodiments a projective filter measurement is performed when |y [symbol] has been evolved into the approximate neighborhood of the desired solution, and the projective filter measurement either succeeds, giving |y [symbol] to high precision, or fails and the method is repeated. Since the Hamiltonian simulation is used as a subroutine, the asymptotic scaling of the method is O(κlog(κ/ϵ).

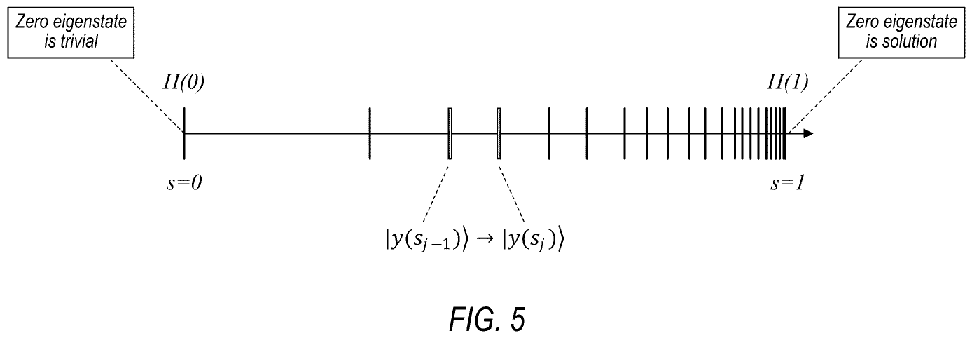

In the adiabatic evolution stage, random times are sampled 228 from a probability distribution for computing quantum signal processing (QSP) phases to evolve an initital state toward the target state. Additionally or alternatively, a discrete adiabatic trajectory is computed 230 (e.g., such as the series of ticks illustrated in FIG. 5). Finally, a quantum processing unit (QPU) (e.g., the controller 106) may direct the quantum computing system to implement an adiabatic evolution circuit on a plurality of qubits to simulate a plurality of randomized Hamlitonian evolution steps 232.

In the filtering stage, the QPU directs the quantum computing system to apply a projective filter measurement circuit on the adiabatically evolved qubits onto a target eigenspace 238. QSP phases for performing the projective filter measurement may have been previously computed 234 via classical processing. The projective filter measurement may produce a success indicator and qubits that may be projected into an approximation of the target state. The success indicator indicates whether the projection resulted in the approximation of the target state or another (undesired) state. A classical processor may determine whether the success indicator indicates success 240. When the success indicator indicates failure, the entire process of preparing qubits into initial states, preparing a first plurality of qubits in the state b and block encoding a second plurality of qubits as the operator A, applying an adiabatic evolution circuit, and applying the projective filter measurement circuit may be repeated. When the success indicator indicates success, output qubits are identified as a coherently encoded solution of the linear equation at step 242. In some embodiments, post-processing 208 is performed, which may include quantum post-processing 244, information extraction to determine the target state 246, and/or classical post-processing 248 to store a representation of the target state and/or properties of the target state in classical memory.

The details of steps 242-246 may depend on the use-case, in various embodiments. For example, in some embodiments the coherently encoded solution may be transformed in some way (e.g. via a spectral analysis technique). In some embodiments, the expectation value of a Hermitian observable in the state may be computed (either with or without processing).

After various optimizations, a closed formula for the query cost Q, given α, κ and ϵ, may be obtained. In some embodiments, A and b are scaled such that the singular values of A lie in [1/κ, 1], |b [symbol] has been normalized such that it is proportional to Σᵢ bᵢ|i [symbol] , and |A⁻¹b [symbol] is the normalized state proportional to A⁻¹|b [symbol] . In some embodiments, a unitary operator U_{A} is utilized that encodes the matrix A/α in its top-left block for a constant α>0, and an oracle (i.e., unitary operator) U_{b} is utilized to prepare |b [symbol] . Systems and methods according to embodiments herein output a quantum state ϵ-close in 1-norm to |A⁻¹b [symbol] , using an expected Q calls to U_{A} or

$${U}_{A}^{†}$$

and 2Q calls to U_{b} or

$${U}_{b}^{†} ,$$

where

$$Q = \{ 3.48198 e α \sqrt{{κ}^{2} + 1} ( ( 1.064 + \frac{0.16}{{κ}^{\frac{1}{3}}} ) πlog ( 2 κ + 3 ) + 1 ) + 6.54 {log}^{2} ( 2 κ + 3 ) ( log ( \frac{red 438 {log}^{2} ( 2 κ + 3 )}{ϵ} ) + 1 ) + ακlog \frac{32}{ϵ} \} , \qquad ( 1 )$$

for any Δ≤0.12 and κ≥11. The success probability is lower bounded by 0.39-0.204ϵ. If the block-encoding of A uses α auxiliary qubits, then the full QLS utilizes 8+a+┌log₂ N┐ logical qubits.

Equation (1) has a complexity of order O(κlogκ, log(1/ϵ)). The conditions on e and K are chosen simply as an example to provide a compact analytical expression, and more generally any desired values for ϵ and κ may be chosen. Note that it is not assumed that κ equals the condition number of A, but simply that it is an upper bound on the condition number. The latter assumption may be made such that it is unnecessary to know the exact value of either ∥A∥ or ∥A⁻¹∥, which may be difficult to compute precisely.

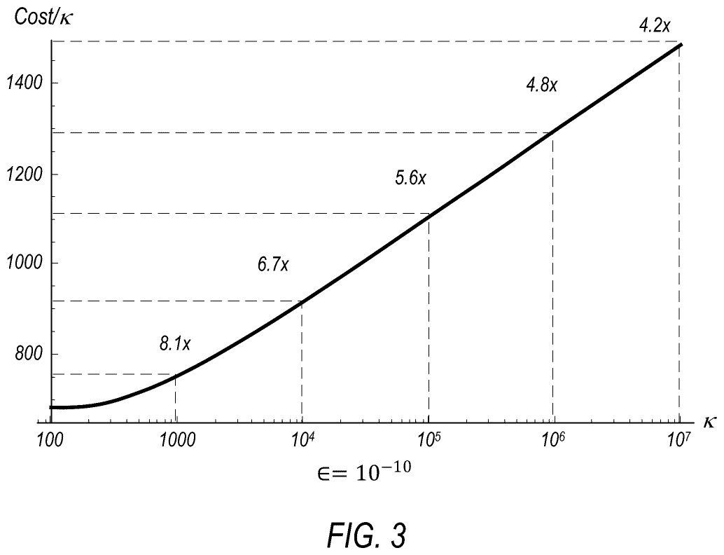

FIG. 3 is a plot of the ratio of computational cost Q divided by the condition number K, for α=1 and ϵ=10⁻¹⁰. The dashed lines in FIG. 3 intersect at points to highlight the relative improvement compared to previous implementations for different values of K.

In some embodiments, Q may be reduced by an additional factor of approximately 3 by performing the Hamiltonian simulation via block-encoding exp[−itH] directly as a complex function, instead of splitting the complex exponential up into cos(Ht) and sin(Ht) and then using Linear Combination of Unitaries to combine the two. However, in the latter case the computation of phase angles is simpler and better developed, which may be desirable in some applications. In some embodiments, the computational cost may be further reduced by a factor of e/2≈1.359 by rigorously establishing better non-asymptotic bounds on Bessel functions for sufficiently large evolution times.

In some embodiments, for sparse matrices, a block-encoding of A may be returned with α=d, where d is the sparsity of A, i.e., the largest number of elements in any of its rows or columns. For well-structured matrices, the sparse access unitaries have polylog(N) gate cost in the dimension N of A. As one example, for d=3 sparse matrices with κ=10³ and ϵ=10⁻¹⁰, the sparse access unitaries may be applied exactly 2,204,110 times. Alternatively, when A may be expanded as a linear combination A=>Σᵢ aᵢAᵢ, with Aᵢ matrices admitting a (αᵢ, m, 0) block-encoding, then α=Σᵢ |αᵢαᵢ| (if Aᵢ are unitaries, then α=∥a∥₁), and the block-encoding may be constructed via ‘Prepare’ and ‘Select’ unitaries. In some embodiments, other constructions to block-encode dense matrices with special structure may be utilized.

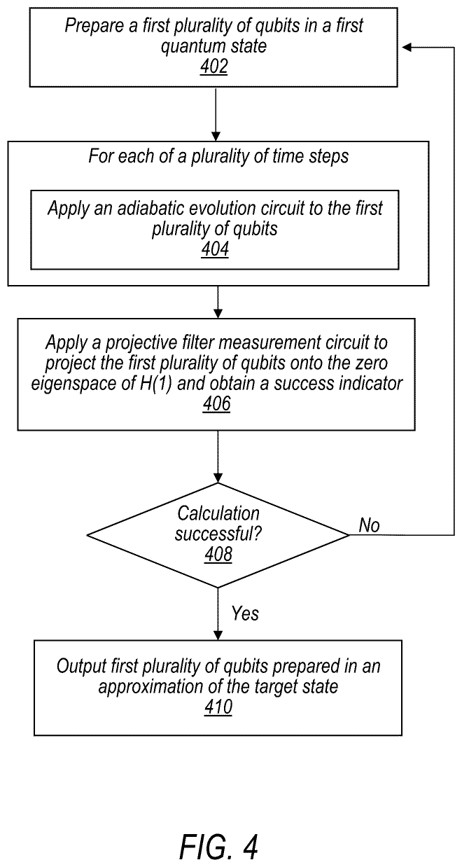

### FIG. 4—Flowchart for Calculating Expectation Value of an Observable

FIG. 4 is a flowchart diagram illustrating a method for utilizing a quantum computing system to solve a quantum linear equation. The method shown in FIG. 4 may be used in conjunction with any of the computer systems or devices shown in the above Figures, among other devices. For example, the method shown in FIG. 4 may be performed by a quantum or classical/quantum hybrid computing device or system 101 as illustrated in FIG. 1. In some embodiments, the described quantum circuit may be implemented in any of a variety of types of quantum computing systems, including but not limited to photonic, semiconductor, superconducting and/or topological quantum computing systems. The quantum computing system may be configured to direct the described method steps, and may include (or be coupled to) a classical computing system 103 for processing classic information and directing operations of the quantum computing device. It is to be understood this method may be used by any of a variety of types of quantum computing architectures, and these other types of systems should be considered within the scope of the embodiments described herein.

The methods shown in FIG. 4 may be used to solve a linear equation of the form Ay=b, where A is a matrix or operator (referred to in FIG. 4 as the “first operator”), y is a state or vector referred to as the “target state”, and b is a state or vector referred to as the “first quantum state”. The linear equation may be related to a quantum mechanical system, such that A is quantum mechanical operator and |y [symbol] and |b [symbol] are quantum states. Alternatively, in some embodiments the linear equation is unrelated to quantum systems (e.g., it may be related to a data fitting or machine learning problem, among other possibilities), and A is simply a matrix while y and b are vectors. In either case, the quantum linear solver receives a description of A and b as inputs, encodes them in qubits as quantum states, and a plurality of qubits prepared in an approximation of the target state |y [symbol] is produced as an output of the method. The output qubits may then be measured, provided to a subsequent stage of a quantum computation, or otherwise post-processed to produce classical measurement results that are stored in a non-transitory memory medium. The method may additionally receive an error tolerance ϵ for determining the target state, and the method may output a state that is ϵ-close to the target state (i.e., within a distance of ϵ from the target state). In some embodiments, a numerical precision for applying the adiabatic evolution circuit and a numerical precision for block encoding the projective filter measurement circuit may be determined such that the approximation of the target state is within the error tolerance.

In various embodiments, some of the method elements shown may be performed concurrently, in a different order than shown, or may be omitted. Additional method elements may also be performed as desired. As illustrated, the method shown in FIG. 4 may proceed as follows.

At 402, a first plurality of qubits is prepared in a first quantum state |b [symbol] . The first plurality of qubits may be received in an initial state (e.g., the null state) encoded in a fault-tolerant quantum error correcting code, and may be subsequently encoded into the state |b [symbol] through the application of a unitary operator to the initial state (e.g., as described below in reference to Equation 2). A numerical precision for preparing the first quantum state may be determined based on an error tolerance for determining the target state.

At 404, for each of a plurality of respective time steps, an adiabatic evolution circuit is applied to the first plurality of qubits. The adiabatic evolution circuit may be applied using a second plurality of qubits that have been block encoded as a first operator, A. The block encoding of the first operator may take the form of a unitary matrix, e.g., such as that shown in Equations 3a and 3b. Systems and methods for performing block encoding are described in greater detail in the paper “The Power of Block-Encoded Matrix Powers: Improved Regression Techniques via Faster Hamiltonian Simulation”, by Shantanav Chakraborty, András Gilyén, and Stacey Jeffery (ref: In Proceedings of the 46th International Colloquium on Automata, Languages, and Programming (ICALP 2019), pp. 33:1-33:14), which is incorporated by reference in its entirety as though completely set forth herein. The first operator may be block encoded using the second plurality of qubits using quantum signal processing (QSP), in some embodiments. A numerical precision for encoding the first operator may be determined based on an error tolerance for determining the target state. An example of the adiabatic evolution circuit is shown in the quantum circuit diagram illustrated in FIG. 7A. Applying the adiabatic evolution circuit for the respective time step unitarily evolves the first quantum state toward the target state. The target state is a quantum state with the property that the first operator applied to the target state produces the first quantum state. In other words, the target state is the solution |y [symbol] to the linear equation A|y [symbol] =|b [symbol] .

In some embodiments, in applying the adiabatic evolution circuit, an interpolation operator is defined that is a function of a parameter s. The interpolation operator interpolates between a function of an identity operator at s=0 and a function of the first operator at s=1, and is used to adiabatically evolve the state |b [symbol] toward the target state |y [symbol] . This interpolation operator is referenced as A(s), as opposed to the first operator which is referenced as A (written without the s argument). An example form of the interpolation operator A(s) is shown in Equation 5, below.

In some embodiments, the interpolation operator is encoded within a pseudo-Hamiltonian, H(s). For example, the second plurality of qubits may be initially encoded as the operator A, subsequently block encoded as the interpolation operator A(s), and finally encoded as the pseudo-Hamiltonian H(s), which may then be used to adiabatically evolve the first plurality of qubits in time. H(s) is referred to as a pseudo-Hamiltonian, rather than a physical Hamiltonian, because it is a unitary operator that shares some properties with a Hamiltonian (e.g., is suitable for implementing adiabatic evolution according to a “pseudo-time”), but it does not correspond to the energy of an actual physical system. Notably, the linear equation Ay=b is general and may or may not correspond to a particular physical system. An example form of the pseudo-Hamiltonian in terms of the interpolation operator A(s) is given in Equation 4, below.

In some embodiments, each sequential time step of the plurality of time steps corresponds to a sequential value of s from s=0 for an initial time step of the plurality of time steps to s=1 for a final time step of the plurality of time steps. Note that the time steps may be understood as corresponding to a “pseudo-time”, as they do not refer to the evolution of actual time for a physical system. Rather, they are time-like parameters tₛ used in the evolution operator exp[−itₛH(s)], to evolve the first quantum state |b [symbol] toward the target state |y [symbol] for each of a plurality of values of the parameter s.

Applying the adiabatic evolution circuit to the first plurality of qubits may include, for each respective time step of the plurality of time steps, evolving the first plurality of qubits in time according to the pseudo-Hamiltonian, H(s), evaluated for a value of the parameter s that corresponds to the respective time step. For example, for each respective time step, a plurality of qubits may be block encoded as H(s), evaluated at the value of s that corresponds to the respective time step, for performing the adiabatic evolution. This is illustrated schematically in FIG. 5, where the vertical ticks each correspond to a value of the parameter s, which is incrementally increased from s=0 to s=1. Note that the first quantum state |y(s)) goes from |y(0) [symbol] =|0,−, b) to |y(1) [symbol] =|0, +, y [symbol] as the first plurality of qubits are adiabatically evolved toward the target state (see the description following Equation 6 below). Moving from each tick to the subsequent tick involves evolving the first plurality of qubits according to the time step that corresponds to the particular value of s. Note that s values are determined according to an analytic form (see e.g., Eq. 8), but the length of each time step is randomly sampled from a probability distribution that is a function of the value of s (see, e.g., Eq. 11). Accordingly, each time step of the adiabatic evolution circuit applies the operator exp[−itᵢH(sᵢ)] to the first plurality of qubits, for a pseudo-Hamiltonian H(sᵢ) evaluated at a value sᵢ and for a time duration tᵢ sampled from a probability distribution that is a function of sᵢ.

In some embodiments, applying the adiabatic evolution circuit includes performing quantum signal processing (QSP) to obtain a polynomial approximation of a time evolution operator. This is described in greater detail below in the Section “Randomization of Time Steps for pseudo-Hamiltonian Evolution”.

In some embodiments, a parameter, κ, is received that is an upper bound on a condition number of the first operator. In some embodiments, the parameter K is the condition number, but for some operators the exact condition number may be unknown and/or difficult to accurately compute. In these cases, an upper bound on the condition number may suffice. The condition number may be broadly understood as characterizing the computational cost of inverting the first operator. In these embodiments, a total number of time steps of the plurality of respective time steps may be determined based at least in part on κ. For example, Equations 8 and 9a-9b illustrate an example of how the spacing between adjacent values of the parameter s (and hence, the total number of steps since s runs from 0 to 1) depends on the condition number κ.

In some embodiments, the total number of time steps of the plurality of respective time steps is determined based at least in part on a probability of the projective filter measurement successfully obtaining the target state when applying the adiabatic evolution circuit for the total number of time steps. This probability of success is represented in Equation 13 below as 1−γ, and a dependence of this probablity on the number of time steps may be determined. For example, an expected number of attempts that will result in at least one success may be determined based on the parameter γ, a computational cost for the adiabatic evolution may be determined as a function of the number of steps, and the total number of steps may be determined to minimize the cost of iterating the method for the determined number of attempts at the determined cost per attempt.

In some embodiments, the plurality of respective time steps is obtained by random sampling from a probability distribution. The time steps may be sampled from a probability distribution that is a function of the parameter s. In some embodiments, the probability distribution is a function proportional to the square of a Bessel function of the first kind, such as that shown in Equation 11. Alternatively, the probability distribution may be a sinc function, or more generally it may be any type of probability distribution with a characteristic function that has support in an interval of radius Δ around 0 for some constant Δ (i.e., any probability distribution p(t) may be used as long as the Fourier transform of p(t) is non-zero only inside an interval [−Δ, Δ] and is zero outside of this interval).

At 406, after applying the adiabatic evolution circuit for each of the plurality of respective time steps, a projective filter measurement circuit is applied to the first plurality of qubits to produce a success indicator. The projective filter measurement circuit may be applied to the first plurality of qubits in their final adiabatically evolved state. An example of a projective filter measurement circuit is shown in FIG. 8. The success indicator may be a binary indicator that indicates whether the projection filter measurement circuit successfully projected the first plurality of qubits onto an approximation of the target state.

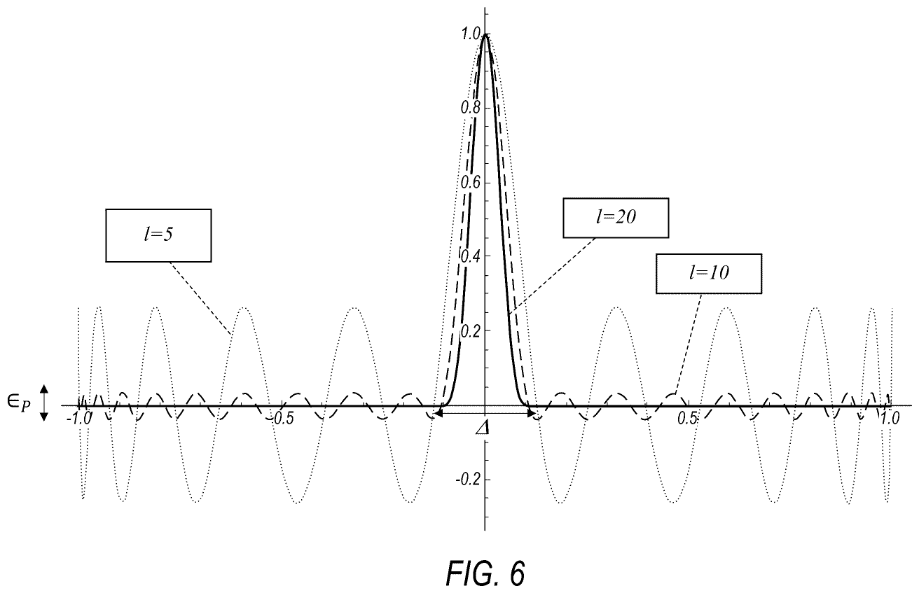

In some embodiments, quantum signal processing (QSP) is performed to obtain a polynomial approximation of a projection operator, R₂ₗ(H, Δ), and the polynomial approximation of the projection operator is used in applying the projective filter measurement circuit. This is described in greater detail below in reference to Equations 15-16. In some embodiments, a filter function such as the one shown in Equation 15 and FIG. 6 is applied to the projection operator to approximate the projection operator via QSP. The projective filter measurement may measure the auxiliary qubits 802 and 804 shown in FIG. 8 to obtain the success indicator, and in the process the first plurality of qubits may be projected onto the zero eigenspace of H(s=1), to potentially be projected into an approximation of the target state.

At 408, it may be determined whether the success indicator indicates that the projection filter measurement circuit was successful, i.e., if the first plurality of qubits were projected onto an E-close approximation of target state. The success indicator may be a binary indicator that indicates one of two values (e.g., 0 or 1) to indicate success or failure, as described in greater detail below in reference to FIG. 8.

In some embodiments, steps 402-406 may be iteratively repeated on new respective pluralities of qubits until the success indicator indicates a success. For example, the projective filter measurement may be probabilistic with some probability of successfully projecting the first plurality of qubits onto the approximation of the target state, and some other probability of projecting the first plurality of qubits onto one or more other states. When it is determined that the projective filter measurement did not successfully project the first plurality of qubits onto the target state (e.g., the projective filter measurement may have projected the first plurality of qubits onto another state), steps 402-406 may be repeated with a new preparation of the first quantum state and the first operator using new respective sets of qubits, followed by repeating the adiabatic evolution and projective filter measurement.

For example, the adiabatic evolution circuit may evolve the first plurality of qubits into the neighborhood (in Hilbert space) of the target state (e.g., so there is a substantial overlap between the state of the first plurality of qubits and the target state). However, evolving the first plurality of qubits to be asymptotically close to the target state may take a significant amount of time and computational resources. In general, the incremental computational cost to get closer to the target state by a given amount increases as you get closer to the target state. Accordingly, the overall time and computational cost to determine the target state may be smaller on average when the projective filter measurement is performed with a substantial probability of failure. For example, if the incremental cost of repeating the preparation of the initial states of the qubits, the adiabatic evolution, and the projective filter measurement is less than the incremental cost of increasing the number of steps in the adiabatic evolution circuit, for a given total probability of achieving at least one successful result, it may reduce the overall cost to repeat the process rather than extend the number of steps. For example, the projective filter measurement (after the additional adiabatic evolution steps) may have a lower probability of success than performing two projective filter measurements (without the additional steps), holding the total computational cost of the two alternatives procedures constant. In some embodiments, empirical data may be obtained to find an ideal balance of how close to evolve the first plurality of qubits toward the target state to obtain a lowest average cost of successfully performing the projective filter measurement after one or more attempts.

At 410, based on a determination that the success indicator indicates success, it may be determined that the first plurality of qubits after a last iteration of applying the projective filter measurement circuit are prepared in an approximation of the target state. In this case, the first plurality of qubits, which are prepared in the approximation of the target state, are output as the solution to the linear equation.

In some embodiments, the first plurality of qubits prepared in the approximation of the target state may be used as input for a subsequent quantum computation. In some embodiments, quantum post-processing may be performed to process and/or measure the first plurality of qubits and obtain classical measurement results that describe the target state and/or properties of the target state. For example, in some embodiments, at least a subset of the first plurality of qubits prepared in the approximation of the target state are measured to produce classical measurement results. In some embodiments, a Fourier transform is performed on the first plurality of qubits prepared in the approximation of the target state, and at least a subset of the first plurality of qubits is measured after performing the Fourier transform to produce classical measurement results. In this case, the classical measurement results may describe spectral properties of the target state. In either case, with or without performing a Fourier transform, the classical measurement results may be stored in a non-transitory computer-readable memory medium.

### Additional Technical Detail

The following numbered paragraphs provide additional technical detail and description regarding embodiments herein, discuss the inner workings of the described methods, and develop an expression for the computational complexity of the computation.

### Setting Up of Problem and Oracle Construction

In some embodiments, a linear system Ay=b is received, together with an upper bound κ on the condition number of A and an error tolerance E. Without loss of generality it may be assumed that A is an N×N non-singular Hermitian matrix with ∥A∥≤1, by an appropriate embedding and rescaling of the linear system.

In some embodiments, two unitaries are constructed (the ‘oracles’):
1. A unitary:

$${U}_{b} \vert 0 〉 := \vert b 〉 ∝ {\sum }_{j = 1}^{N} {b}_{j} \vert j 〉 , \qquad ( 2 )$$

encoding b as a quantum state when applied to a reference state |0 [symbol] .
2. A unitary block-encoding of A, i.e. a unitary matrix with the block form:

$${U}_{A} = [ \begin{matrix}A / α & * \\ * & *\end{matrix} ] , \qquad ( 3 a )$$

where α>0 and * indicates an arbitrary value.

More formally, a (α, α, ϵ)-block-encoding Uₓ of a 2ⁿ×2ⁿ matrix X is a 2^{α+n}×2^{α+n} unitary Uₓ such that:

$${U}_{X} \vert {0}^{a} 〉 \vert {ψ}_{n} 〉 = \vert {0}^{a} 〉 \frac{{X}^{′}}{α} \vert {ψ}_{n} 〉 + \vert ⊥ 〉 , \qquad ( 3 b )$$

where ( [symbol] 0|^{α}⊗Iₙ)|⊥ [symbol] =0 and ∥X−X′∥≤ϵ. Here |ψₙ [symbol] denotes an arbitrary n-qubit state and Iₙ is the identity over n qubits. In other words, Uₓ encodes in a block (identified by the first a qubits being in state zero) a matrix proportional to X′, which is ϵ-close to X. The central goal of a quantum linear solver is to output an approximation to the quantum state |y [symbol] that satisfies the error tolerance ϵ, where:

$$\vert y 〉 ∝ {A}^{- 1} \vert b 〉$$

Said another way, the output of the quantum linear solver is a plurality of qubits prepared in a quantum state that is ϵ-close to the target state |y [symbol] . The computational cost of the problem is quantified in terms of the query complexity Q of the number of times U_{A},

$${U}_{A}^{†} ,$$

### U_{b}, and

$${U}_{b}^{†}$$

are implemented in order to realise this output.

Embodiments herein are problem-agnostic, and assume access to an (α, a, 0)-block-encoding of the linear system matrix A.

### Hamiltonian Encoding and Adiabatic Protocol Via Randomized Hamiltonian Evolution

Embodiments herein encode the solution of the quantum linear system as a zero eigenstate of a particular Hamiltonian. A family of Hamiltonians may be introduced:

$$H ( s ) = {σ}^{+} ⊗ A ( s ) {P}_{\overline{b}}^{⊥} + {σ}^{-} ⊗ {P}_{\overline{b}}^{⊥} A ( s ) , \qquad ( 4 )$$

$$s ∈ [ 0 , 1 ] ,$$

where

$${σ}^{\pm } = ( X \pm iY ) / 2 ,$$

$${P}_{\overline{b}}^{⊥} = I - \vert \overline{b} 〉 〈 \overline{b} \vert ,$$

$$\vert \overline{b} 〉 = \vert + , b 〉 ,$$

and A(s) interpolates between the trivial operator Z⊗I and X⊗A:

$$A ( s ) = ( 1 - s ) Z ⊗ I + sX ⊗ A . \qquad ( 5 )$$

In particular, if N=2ⁿ then H(s) defines a one-parameter family of Hamiltonians on n+2 qubits. If we define states |y(s) [symbol] ∝|0 [symbol] ⊗A(s)⁻¹|b̅ [symbol] , then we have that the family of states {|y(s) [symbol] } are zero eigenstates of H(s) and

$$H ( s ) \vert y ( s ) 〉 = 0 , \qquad ( 6 )$$

for all s∈[0,1]. Moreover, for every s the zero eigenspace of H(s) is 2-dimensional with {|y(s) [symbol] , |y̅ [symbol] =|1, b̅ [symbol] }, which provide an orthonormal basis. The input b and solution y to the linear system are encoded in the zero eigenstates via |y(0) [symbol] =|0,−, b [symbol] and |y(1) [symbol] =|0, +, y [symbol] .

The quantum adiabatic theorem tells us that if we start from a preparation of |y(0) [symbol] and evolve under the Hamiltonian H(s) while changing the parameter s sufficiently slowly, an output \tilde{ρ}(1) is obtained that is a good approximation to |y(1) [symbol] . This works even if the zero eigenspace of H(s) is a 2-dimensional space spanned by {|y(s)), |y̅ [symbol] }, because the evolution under H(s) does not cause any transition between the two orthogonal zero eigenstates.

The adiabatic protocol proceeds as follows: γ is fixed to the range γ∈(0,1), where 1−γ encodes the fidelity to which the adiabatic protocol tries to prepare |y(1) [symbol] . Given κ and γ, we partition the interval

$$[ 0 , 1 ] = {⊔}_{j = 1}^{q} [ {s}_{j - 1} , {s}_{j} ] ,$$

where 0=s₀< . . . <s_{q}=1. Let Δ(s) be a lower bound on the gap between the zero and nonzero energies of H(s). We can take

$$Δ ( s ) = \sqrt{{( 1 - s )}^{2} + {( s / κ )}^{2}} . \qquad ( 7 )$$

The schedule is chosen with a partitioning that is finer closer to s=1, where Δ(s) is smaller. Specifically, we reparametrize s=s(v), where

$$s ( v ) = \frac{- {κ}^{2} exp ( - v \frac{\sqrt{{κ}^{2} + 1}}{\sqrt{2} κ} ) + exp ( v \frac{\sqrt{{κ}^{2} + 1}}{\sqrt{2} κ} ) + 2 {κ}^{2}}{2 ( {κ}^{2} + 1 )} , \qquad ( 8 )$$

and define sⱼ=s(vⱼ), where {v₀, v₁, v₂, . . . , v_{q}} forms an evenly spaced set of q+1 points between v₀=vₐ and v_{q}=v_{b}, i.e., vⱼ=vₐ+j(v_{b}−vₐ)/q, where

$${v}_{a} = \frac{\sqrt{2} κ}{\sqrt{1 + {κ}^{2}}} log ( κ \sqrt{1 + {κ}^{2}} - {κ}^{2} ) , \qquad ( 9 a )$$

$${v}_{b} = \frac{\sqrt{2} κ}{\sqrt{1 + {κ}^{2}}} log ( κ \sqrt{1 + {κ}^{2}} + 1 ) . \qquad ( 9 b )$$

These satisfy s(vₐ)=0, s(v_{b})=1. In some embodiments, sⱼ may be chosen to satisfy

$${s}_{j} := s ( {v}_{a} + \frac{( {v}_{b} - {v}_{a} )}{q} j ) ,$$

$$j = 1 , … , q .$$

### Randomization of Time Steps for Pseudo-Hamiltonian Evolution

For each j=1, . . . , q, time-independent Hamiltonian simulation is performed under the pseudo-Hamiltonian H(sⱼ), for a random time tⱼ chosen from a particular distribution. A quantum channel is thereby effected:

$${𝒫}_{j} ( ρ ) = {P}_{j}^{0} {ρ P}_{j}^{0} + {ε}_{j} ∘ ( I - {P}_{j}^{0} ) ρ ( I - {P}_{j}^{0} ) , \qquad ( 10 )$$

where

$${P}_{j}^{0}$$

is the projector onto the zero eigenspace of H(sⱼ) and εⱼ is an arbitrary channel that acts in the case of post-selection onto nonzero eigenspaces. The full channel [symbol] ⱼ effectively acts as a non-selective measurement, in the eigenbasis of H(sᵢ), evolving the instantaneous eigenstate from |y(sⱼ₋₁) [symbol] to |y(sⱼ) [symbol] with sufficiently high probability.

In some embodiments, instead of randomized Hamiltonian simulation, the application of

$${P}_{j}^{0}$$

at each step may be approximated via QSP (‘filtering’). The former approach gives an additive log(1/ϵ) contribution to the cost, whereas the latter gives a multiplicative contribution to it. When ϵ is small, Hamiltonian simulation may lead to a reduced computational cost.

To perform Hamiltonian simulation, a block-encoding of H(s) may be utilized. A (αₛ, a+3,0)-block-encoding of H(s) with αₛ=(1−s)+αs may be obtained from a (1, a, 0)-block-encoding of A using a linear combination of unitaries technique. The linear combination of unitaries decomposition instead has αₛ=2(α+1). Since αₛ enters linearly in Q, this construction cuts costs by about a factor of 2.

A channel of the form shown in Equation (10) is realized exactly if the evolution time tⱼ is sampled from a probability distribution whose characteristic function has support limited to the range [−Δ, Δ]. Optimizing over the average evolution time at step j, [symbol] |t| [symbol] ⱼ, results in:

$${p}_{j} ( t ) ∝ {( \frac{{J}_{a} ( Δ ( {s}_{j} ) \vert t \vert / 2 )}{{Δ}^{a - 1} {\vert t \vert}^{a}} )}^{2} , \qquad ( 11 )$$

where Jₐ is the Bessel function of first kind of order α=1.165. We get [symbol] |t| [symbol] ⱼ=2.32132/Δ(sⱼ), with variance 9.36238/(Δ(sⱼ))². The intuition here is that by sampling according to a distribution pⱼ(t) and then implementing Hamiltonian simulation for this randomly selected time tⱼ, a quantum channel is generated that approximates one of the form [symbol] ⱼ above. The error governing this approximation is given by the maximum of the characteristic function of pⱼ(t) evaluated at the energy gaps of H(sⱼ). Therefore if one uses a distribution that is bandwidth limited to [−Δ, Δ], the error vanishes and a channel of the form [symbol] ⱼ is realized exactly.

However, this raises the question of a desirable probability distribution to use, which minimizes [symbol] |tⱼ| [symbol] and has a finite variance. The above distribution shown in Equation 11 is one possibility, in some embodiments, and has [symbol] |t| [symbol] ⱼ, which is a 13.3% reduction from a distribution proportional to sinc⁴(Δ(sⱼ)t/4). In some embodiments, classical signal processing theory may be used to determine a well-performing probability distribution.

Adiabatic protocol. In some embodiments, a sequence of Hamiltonian simulation steps are performed exp[−it₁H(s₁)], . . . , exp[−it_{q}H(s_{q})] for the randomly chosen times tⱼ at each of the q intervals, via QSP. Since Hamiltonian simulation is not perfect, at each step an approximate channel [symbol] ⱼ is realized, such that [symbol] ⱼ≈ [symbol] ᵢ. For clarity we refer to [symbol] ⱼ as the ideal adiabatic protocol. At each step under the ideal protocol, the state goes from |y(sⱼ₋₁) [symbol] to |y(sⱼ) [symbol] , with high fidelity, but even in the ideal case some noise is introduced in each step due to the probability of projecting out of the zero eigenspace, as specified in the second term of Eq. (10). This noise arises due to the finite number of discrete steps taken, and by increasing q it can be appropriately reduced. After q steps of the ideal protocol we obtain a state

$$ρ ( 1 ) = {𝒫}_{q} ∘ … ∘ {𝒫}_{1} ( ρ ( 0 ) ) , \qquad ( 12 )$$

that obeys

$$〈 y ( 1 ) \vert ρ ( 1 ) \vert y ( 1 ) 〉 \geq 1 - γ . \qquad ( 13 )$$

In an actual implementation, an approximate output state is obtained, \tilde{p}(1) from the adiabatic evolution circuit.

FIG. 7A is a quantum circuit diagram illustrating an example adiabatic evolution circuit 264. FIG. 7A illustrates one non-limiting example of a quantum circuit to perform adiabatic evolution, but it is within the scope of the described embodiments to perform adiabatic evolution on the state |y(0) [symbol] using an of a variety of quantum circuits, as desired. The adiabatic evolution circuit receives |b [symbol] encoded in a first plurality of qubits as input, which is transformed to |y(0) [symbol] as described above. A second plurality of qubits are also received that have been prepared in the null state 704, and these qubits will be used to encode the operator A, which is transformed to the adiabatic evolution operator exp[−itᵢH(sᵢ)] for i={1 . . . q} according to Equations 4 and 5. Here tᵢ is a random pseudo-time sampled from the probability distribution given in Equation 11. The operator exp[−itᵢH(sᵢ)] is repeatedly applied (706a, 706b) to the input qubits for sequential values of i, evolving the qubits to the output state \tilde{p}(1) 708, which may be provided as input to the projective filter measurement circuit shown in FIG. 8.

An example implementation of the subroutines exp[−itᵢH(sᵢ)] (706a, 706b) is illustrated in the quantum circuit diagram shown in FIG. 7B. Note that FIG. 7B is one example of a quantum circuit configured to apply the operator exp[−itᵢH(sᵢ)], and other implementations are also within the scope of some embodiments. As illustrated, register qubits |1 [symbol] , |0 [symbol] , and |0^{α+2} [symbol] are utilized for storing and accessing the block encoding of the operator A, and the state |ψ [symbol] represents the first plurality of qubits in their present state (i.e., in some intermediate state between |y(0) [symbol] and \tilde{ρ}(1), depending on the value of k. Note that the |0^{α+2} [symbol] qubits correspond to the “second plurality” of qubits that are used to encode A, e.g., the qubits 204 in FIG. 2A and the qubits 704 in FIG. 7A. The constant “a” in FIG. 7B denotes the number of qubits used to block encode the operator A, and the additional 2 qubits enable the block encoding of the interpolation operator, A(s). For example, the plurality of qubits 704 may be block encoded as A and subsequently used to encode the interpolation operator H(s) using the additional 2 register qubits. The term R_{z}(θ₀ⱼ) denotes classically precomputed phase angels for the Jacobi-Angers approximation of cos x, and R_{z}(θ₁ⱼ) denotes classically precomputed phase angels for the Jacobi-Angers approximation of sin x.

In some embodiments, taking q=(v_{b}−vₐ)²/γ achieves 1−γ fidelity with the target |y(1) [symbol] . This requirement on the number of steps can be improved by taking the smallest integer q that satisfies

$${( 1 - \frac{{( {v}_{b} - {v}_{a} )}^{2}}{{q}^{2}} )}^{q} \geq 1 - γ .$$

In some embodiment, for γ=0.61 and κ≥84, q is selected such that q=(1.064+0.16/κ^{1/3})(v_{b}−vₐ)². Other selections for the value of q are also possible, in various embodiments. Even though a value of γ=0.61 will result in a substantial probability that the projective filter measurements fails to obtain a the target state, it may reduce the overall cost of the algorithm to repeat the adiabatic process and reattempt the projective filter measurement, rather than extending the computational cost of the adiabatic evolution circuit by further increasing the number of steps.

Hamiltonian simulation cost. Besides the error due to finite steps, there is also noise introduced by realizing time evolution up to finite precision. In some embodiments, Hamiltonian simulation is realized using QSP via the Jacobi-Anger expansion. Given a (α_{H}, m_{H}, 0)-block-encoding U_{H} of a Hermitian H with ∥H∥≤1, a (1, m_{H}+2, δ) block-encoding of e^{-iH}^{_{τ}} may be obtained with exactly

$$3 ⌈ e {α}_{H} τ / 2 + log ( 2 c / δ ) ⌉ , \qquad ( 14 )$$

calls to U_{H} or

$${U}_{H}^{†} ,$$

with c≈1.47762. This non-asymptotic bound is of independent interest. Using Eq (14) the total expected cost of the adiabatic step may be computed analytically in the non-ideal scenario. The standard deviation of the cost of the adiabatic stage may be 11-20% of its expected cost, depending on K. It may be reduced to 8-12% by replacing Eq. (11) with a variance-optimized distribution, whose average is around 5% higher.

Taking δ=O(ϵ/q), the total cost of Step 2 is of order

$$O ( \frac{κ}{γ} log \frac{κ}{γ} + log ( {log ( \frac{κ}{γ} )}^{2} / ϵ ) ) .$$

The output is a mixed state 1−γ−O(ϵ)-close to |y(1) [symbol] .

Step 3: projection on the correct solution. In some embodiments, the above adiabatic protocol is used to prepare an approximate state for some constant γ and then an O(ϵ)-approximate projection is applied onto the zero eigenspace of H(1), with a query cost O(κlog(1/ϵ)).

In some embodiments, a projective filter measurement is utilized. Given an (α, m, 0)-block-encoding of a Hamiltonian H with zero gap lower bounded by Δ, the projector P₀ is approximated onto its zero eigenspace via QSP as the degree-2l matrix polynomial R₂ₗ (H, Δ), where

$${R}_{2 l} ( x , Δ ) = \frac{{T}_{l} ( - 1 + 2 \frac{{x}^{2} - {Δ}^{2}}{1 - {Δ}^{2}} )}{{T}_{l} ( - 1 - 2 \frac{{Δ}^{2}}{1 - {Δ}^{2}} )} , \qquad ( 15 )$$

and Tₗ(x) is the order-l Chebyshev polynomial of the first kind. R₂ₗ(H, Δ) is plotted as a function of Δ in FIG. 6 for three different values of l. Among all degree 2l polynomials q₂ₗ(x) with |q₂ₗ(x)|≤1 in [−1,1] and q₂ₗ(0)=1, R₂ₗ(H, Δ) is the one with the minimal max error max_{x∈[-1,-Δ]∪[Δ,1]}|q₂ₗ(x)|. Moreover, R₂ₗ(H, Δ) satisfies

$$‖ {R}_{2 l} ( H , Δ ) - {P}_{0} ‖ \leq {ϵ}_{P} , \qquad ( 16 )$$

using

$$2 l = ⌈ \frac{α}{Δ} log ( \frac{2}{{ϵ}_{P}} ) ⌉$$

calls to U_{H} or

$${U}_{H}^{†}$$

and 1 extra qubit. Note that the brackets ┌x┐ denote the largest integer that is not greater than the value of x, and

$${ϵ}_{P} = \frac{0.39}{6.1} ϵ .$$

The projection operator R₂ₗ(H, Δ) also satisfies R₂ₗ(H, Δ)|ψ₀ [symbol] =|ψ₀ [symbol] for all |ψ₀ [symbol] in the zero eigenspace of H. Therefore we obtain a (1, m+1, ϵₚ)-block-encoding of P₀. This approximate projection may be implemented on the state ρ(1), with H=H(1) (the Hamiltonian at the end of the adiabatic trajectory), Δ=1/κ (the lower bound on the final gap) and m=a+3. For an appropriate choice of E, if we succeed we output an e-approximation to the solution vector |y(1) [symbol] (and so |y) [symbol] . Otherwise, we go back to Step 2 and repeat. The success indicator indicates whether the projection filter measurement resulted in the desired solution or not.

Accounting for all the three steps and the repetition, the dominant contributions to the cost of the algorithm are

$$\tilde{O} ( \frac{κ}{γ ( 1 - γ )} log \frac{κ}{ϵ} ) \cdot γ$$

is a parameter to be optimized, but the above suggests y~½ will be optimal. By computing the cost at different κ by computing q numerically, it may be found that the best choice of y has weak K and e dependence. Numerics suggests taking γ=0.61, which may be used, in some embodiments.

FIG. 8 is quantum circuit diagram for implementing quantum signal processing (QSP) for block encoding the projection operator R₂ₗ(H, Δ) and performing a projective filter measurement, according to some embodiments. Note that FIG. 8 is merely one example of a quantum circuit configured to perform a projective filter measurement, and various modifications and alternative circuits may also be used, in various embodiments. As illustrated, a plurality of qubits is received that is prepared in the state \tilde{ρ}(1), as output by the adiabatic evolution circuit shown in FIG. 7A. The circuit also receives as input a qubit 802 prepared in the logical |1 [symbol] state and a+2 qubits prepared in the null state 804. The a+2 qubits |0^{α+2} [symbol] may be utilized as a quantum register to store the block encoding of U_{H(1)}, similar to the qubits |0^{α+2} [symbol] described in reference to FIG. 7B, but with the value of the parameter s always taken to equal 1. The constant “a” in FIG. 8 denotes the number of qubits used to block encode the operator A, and the additional 2 qubits enable the block encoding of the interpolation operator, A(s).

A Hadamard gate 808a is applied to the qubit 802, followed by a controlled-NOT (CNOT) gate 810a on the qubits 802 and 804, a phase operator φ₁ on the the qubit 802, a CNOT gate 810b on the qubits 802 and 804, and a unitary operator U_{H(1)} 814a applied to the qubits 804 and 806. The unitary operator U_{H(1)} may be a unitary block encoding of the pseudo-Hamiltonian operator H(1). This sequence is repeated 21 times, where each repetition alternates whether UH (1) (814a) or U^{†}_{H(1)} (814b) is applied to the qubits 804 and 806. The sequence of phases φ₁ . . . φ₀ may be determined using QSP classical pre-processing to properly block encode the projective filter operator. Finally, a sequence of a CNOT gate 810e, a phase φ₀ 812c, a CNOT gate 810f, and a Hadamard gate 808b are applied to the qubits 802 and 804, as shown.

After these operations have been performed, the qubits 802 and 804 are measured at steps 818 and 820, respectively, to produce a success indicator. When the projective filter measurement has successfully projected the qubits 806 into the null state of the pseudo-Hamiltonian H(1), the measurements 818 and 820 will each produce a null result. If any of the measurement results 818 and 820 are not a null result, the success indicator indicates failure, and the entire method may be repeated, as described in FIG. 2A. Accordingly, the success indicator is a classical measurement result of the qubits 802 and 804 that indicates whether the qubits 806 have been successfully projected into the desired target state. The qubits 806 are output in the state |ψ [symbol] , which is either output as the desired target state, or discarded as an unsuccessful result, depending on the success indicator.

It should be understood that all numerical values used herein are for purposes of illustration and may be varied. In some instances, ranges are specified to provide a sense of scale, but numerical values outside a disclosed range are not precluded.

It should also be understood that all diagrams herein are intended as schematic. Unless specifically indicated otherwise, the drawings are not intended to imply any particular physical arrangement of the elements shown therein, or that all elements shown are necessary. Those skilled in the art with access to this disclosure will understand that elements shown in drawings or otherwise described in this disclosure may be modified or omitted and that other elements not shown or described may be added.

This disclosure provides a description of the claimed invention with reference to specific embodiments. Those skilled in the art with access to this disclosure will appreciate that the embodiments are not exhaustive of the scope of the claimed invention, which extends to all variations, modifications, and equivalents.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

It will also be understood that, although the terms first, second, etc., are, in some instances, used herein to describe various elements, these elements should not be limited by these terms. These terms are only used to distinguish one element from another. For example, a first switch could be termed a second switch, and, similarly, a second switch could be termed a first switch, without departing from the scope of the various described embodiments. The first switch and the second switch are both switches, but they are not the same switch unless explicitly stated as such.

As used herein, the term “if” is, optionally, construed to mean “when” or “upon” or “in response to determining” or “in response to detecting” or “in accordance with a determination that,” depending on the context.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

1. A method, comprising:
iteratively performing, until a success indicator indicates success:
preparing a first plurality of qubits in a first quantum state;
for each of a plurality of respective time steps:
applying an adiabatic evolution circuit to the first plurality of qubits using a second plurality of qubits that have been encoded as a first operator to unitarily evolve the first quantum state for the respective time step toward a target state; wherein the first operator applied to the target state produces the first quantum state; and
after applying the adiabatic evolution circuit for each of the plurality of respective time steps, applying a projective filter measurement circuit to the first plurality of qubits to produce the success indicator;
based on a determination that the success indicator indicates success, determining that the first plurality of qubits after a last iteration of applying the projective filter measurement circuit are prepared in an approximation of the target state; and
outputting the first plurality of qubits prepared in the approximation of the target state.

2. The method of claim 1,
wherein the plurality of respective time steps is obtained by random sampling from a probability distribution, and
wherein the probability distribution comprises a function proportional to the square of a Bessel function of the first kind.

3. The method of claim 1, further comprising:
receiving an error tolerance, e, for determining the target state; and
determining, by a classical processor, a numerical precision for applying the adiabatic evolution circuit and a numerical precision for block encoding the projective filter measurement circuit such that the approximation of the target state is within the error tolerance.

4. The method of claim 1, further comprising:
defining a pseudo-Hamiltonian operator, H(s), that comprises a function of a parameter s, wherein H(s) interpolates between a function of an identity operator at s=0 and a function of the first operator at s=1, wherein each sequential time step of the plurality of time steps corresponds to a sequential value of s from s=0 for an initial time step of the plurality of time steps to s=1 for a final time step of the plurality of time steps.

5. The method of claim 4, further comprising:
for each respective time step of the plurality of time steps, block encoding the second plurality of qubits encoded as the first operator as the pseudo-Hamiltonian operator, H(s), evaluated at a respective value of s that corresponds to the respective time step,
wherein applying the adiabatic evolution circuit to the first plurality of qubits comprises, for each respective time step of the plurality of time steps, evolving the first plurality of qubits in time according to the pseudo-Hamiltonian, H(s.

6. The method of claim 1, further comprising:
receiving a parameter, K, that comprises an upper bound on a condition number of the first operator; and
determining a total number of time steps of the plurality of respective time steps based at least in part on K.

7. The method of claim 1, further comprising:
determining a total number of time steps of the plurality of respective time steps based at least in part on a probability that applying the projective filter measurement circuit successfully prepares the first plurality of qubits in the approximation of the target state after applying the adiabatic evolution circuit for the total number of time steps.

8. The method of claim 1
wherein applying the adiabatic evolution circuit comprises performing quantum signal processing (QSP) to obtain a polynomial approximation of a time evolution operator.

9. The method of claim 1,
wherein applying the projective filter measurement circuit comprises performing quantum signal processing (QSP) to obtain a polynomial approximation of a projection operator to project the first plurality of qubits onto a zero eigenspace of a pseudo-Hamiltonian operator, H(s).

10. The method of claim 1, further comprising:
measuring at least a subset of the first plurality of qubits in the approximation of the target state to produce classical measurement results; and
storing the classical measurement results in a non-transitory computer-readable memory medium.

11. The method of claim 1, further comprising:
performing a Fourier transform on the first plurality of qubits in the approximation of the target state;
after performing the Fourier transform, measuring at least a subset of the Fourier transformed first plurality of qubits in the approximation of the target state to produce classical measurement results, wherein the classical measurement results describe spectral properties of the target state; and
storing the classical measurement results in a non-transitory computer-readable memory medium.

12. A quantum circuit, comprising:
a first plurality of qubits prepared in a first quantum state;
an adiabatic evolution circuit configured to be applied to the first plurality of qubits using a second plurality of qubits that have been encoded as a first operator to, for each of a plurality of respective time steps:
unitarily evolve the first quantum state for the respective time step toward a target state; wherein the first operator applied to the target state comprises the first quantum state;
a projective filter measurement circuit configured to, after applying the adiabatic evolution circuit for each of the plurality of respective time steps, be applied to the first plurality of qubits to produce a success indicator;
wherein the quantum circuit is configured to receive first instructions from a classical processor to output the first plurality of qubits prepared in the approximation of the target state, wherein the instructions are received responsive to the success indicator indicating that the first plurality of qubits is prepared in an approximation of the target state after application of the projective filter measurement circuit to the first plurality of qubits.

13. The quantum circuit of claim 12,
wherein the plurality of respective time steps is obtained by random sampling from a probability distribution, and
wherein the probability distribution comprises a function proportional to the square of a Bessel function of the first kind.

14. The quantum circuit of claim 12, wherein the quantum circuit is further configured to:
receive, from the classical processor, a numerical precision for applying the adiabatic evolution circuit and a numerical precision for block encoding the projective filter measurement circuit such that the approximation of the target state is within an error tolerance, E, for determining the target state.

15. The quantum circuit of claim 12, wherein the quantum circuit is further configured to:
for each respective time step of the plurality of time steps, block encoding the second plurality of qubits encoded as the first operator as a pseudo-Hamiltonian operator, H(s), evaluated at a respective value of s that corresponds to the respective time step, wherein H(s) comprises a function of a parameter s, wherein H(s) interpolates between a function of an identity operator at s=0 and a function of the first operator at s=1, wherein each sequential time step of the plurality of time steps corresponds to a sequential value of s from s=0 for an initial time step of the plurality of time steps to s=1 for a final time step of the plurality of time steps,
wherein applying the adiabatic evolution circuit to the first plurality of qubits comprises, for each respective time step of the plurality of time steps, evolving the first plurality of qubits in time according to the pseudo-Hamiltonian, H(s), evaluated for the respective value of s that corresponds to the respective time step.

16. The quantum circuit of claim 12,
wherein the quantum circuit is further configured to receive second instructions from the classical processor to:
prepare a third plurality of qubits in the first unitary state;
for each of a plurality of respective second time steps:
apply the first adiabatic evolution circuit to the third plurality of qubits using a fourth plurality of qubits that have been encoded as the first operator to evolve the first unitary state for the respective second time step toward the target state;
after applying the first adiabatic evolution circuit for each of the plurality of respective second time steps, apply the projective filter measurement circuit to the third plurality of qubits to produce a second success indicator; and
based on the second success indicator indicating that the third plurality of qubits is prepared in the approximation of the target state after application of the projective filter measurement circuit to the third plurality of qubits, output the third plurality of qubits prepared in the approximation of the target state,
wherein the second instructions are received responsive to a determination that the success indicator indicates failure.

17. A non-transitory computer-readable memory medium storing program instructions which, when executed by a processor, cause a quantum computing system to:
receive a first plurality of qubits in a first quantum state;
for each of a plurality of respective time steps:
apply an adiabatic evolution circuit to the first plurality of qubits using a second plurality of qubits that have been encoded as a first operator to unitarily evolve the first quantum state for the respective time step toward a target state; wherein the first operator applied to the target state comprises the first quantum state; and
after applying the adiabatic evolution circuit for each of the plurality of respective time steps, apply a projective filter measurement circuit to the first plurality of qubits to produce the success indicator;
determine, based on the success indicator, that the first plurality of qubits is prepared in an approximation of the target state after application of the projective filter measurement circuit to the first plurality of qubits; and
output the first plurality of qubits prepared in the approximation of the target state.

18. The non-transitory computer-readable memory medium of claim 17,
wherein the plurality of respective time steps is obtained by random sampling from a probability distribution, and
wherein the probability distribution comprises a function proportional to the square of a Bessel function of the first kind.

19. (canceled)

20. The non-transitory computer-readable memory medium of claim 17, wherein the program instructions are further executable to cause the quantum computing system to:
for each respective time step of the plurality of time steps, block encoding the second plurality of qubits encoded as the first operator as a pseudo-Hamiltonian operator, H(s), evaluated at a respective value of s that corresponds to the respective time step, wherein H(s) comprises a function of a parameter s, wherein H(s) interpolates between a function of an identity operator at s=0 and a function of the first operator at s=1, wherein each sequential time step of the plurality of time steps corresponds to a sequential value of s from s=0 for an initial time step of the plurality of time steps to s=1 for a final time step of the plurality of time steps,
wherein applying the adiabatic evolution circuit to the first plurality of qubits comprises, for each respective time step of the plurality of time steps, evolving the first plurality of qubits in time according to the pseudo-Hamiltonian, H(s), evaluated for the respective value of s that corresponds to the respective time step.

21. A method for using a quantum computing system to solve the linear equation Ay=b for a vector y given a matrix A and a vector b, the method comprising:
iteratively performing, until a success indicator indicates success:
preparing a first plurality of qubits in a first quantum state corresponding to the vector b;
for each of a plurality of respective time steps:
applying an adiabatic evolution circuit to the first plurality of qubits using a second plurality of qubits that have been encoded as a first operator to unitarily evolve the first quantum state for the respective time step toward a target state corresponding to the vector y, wherein the first operator corresponds to the matrix A; and
after applying the adiabatic evolution circuit for each of the plurality of respective time steps, applying a projective filter measurement circuit to the first plurality of qubits to produce the success indicator;
based on a determination that the success indicator indicates success, determining that the first plurality of qubits after a last iteration of applying the projective filter measurement circuit are prepared in an approximation of the target state; and
outputting the first plurality of qubits prepared in the approximation of the target state.
